(19) United States
(12) Patent Application Publication
(10) Pub. No.: US 2026/0218549 A1
(43) Pub. Date: Jul. 30, 2026

(54) VEHICLE DOOR OUTER HANDLE DEVICE

(71) Applicant: Minebea AccessSolutions Inc., Miyazaki-shi (JP)

(72) Inventor: Yasuhiro SAITOU, Miyazaki (JP)

(21) Appl. No.: 19/456,370

(22) Filed: Jan. 22, 2026

(30) Foreign Application Priority Data
Jan. 27, 2025 (JP) 2025-011474

(51) Int. Cl. E05B 85/16; E05B 85/10

(52) U.S. Cl. CPC E05B 85/16; E05B 85/103

(57) ABSTRACT

A vehicle door outer handle device includes a handle rotatable between a storage position when stored in a base and an emergency operation position when rotated to a vehicle exterior side, and a traction member configured to switch a door latch device to an unlatched state. An operation member operable when the handle is rotated at least to the emergency operation position and a coupling lever configured to move in conjunction with an operation of the operation member and be able to directly transmit operating force of the operation member to the traction member are attached to the base.

### CROSS REFERENCE TO RELATED APPLICATION

This application claims benefit of priority to Japanese Patent Application 2025-011474, filed on January 27, 2025, the entire content of which is incorporated herein by reference.

### BACKGROUND

### Technical Field

The present invention relates to a vehicle door outer handle device.

### Background Art

A vehicle door inner handle device (hereinafter, referred to as a “handle device”) disclosed in JP 4914478 B includes a base attached to a vehicle door and a handle attached to the vehicle exterior side of the base. The handle is rotatable, via a normal operation position, between a storage position in which the handle is stored in a recessed portion of the base and an emergency operation position in which the handle is rotated from the storage position toward the vehicle exterior side.

When the rotating operation of the handle from the storage position to the normal operation position is detected by a switch in a normal state in which the battery capacity of a vehicle is sufficient, a control unit electrically switches a door latch device attached to the same door as the handle device to an unlocked state and an unlatched state, and thus the door can be opened. The door latch device is manually switched to the unlatched state via a cable connected to the handle by rotationally operating the handle from the storage position to the emergency operation position via the normal operation position in an emergency state in which the battery capacity of the vehicle is insufficient, and thus the door can be opened.

The handle device of JP 4914478 B further includes a restriction mechanism for avoiding contention between an electric unlatch operation and a manual unlatch operation of the door latch device in a normal state. By locking between a locking portion provided on an operation member and a locked portion provided on the handle, the restriction mechanism allows the handle to rotate from the storage position to the normal operation position and restricts the handle from rotating from the normal operation position to the emergency operation position. In addition, the handle device includes a restriction release mechanism including an elongated hole portion provided in the operation member and a shaft portion provided at the base. In an emergency state, the operation member is moved along the elongated hole portion to release the locking between the locking portion and the locked portion, thereby releasing the rotation restriction of the handle by the restriction mechanism. As a result, the handle can be rotated from the storage position to the emergency operation position.

### SUMMARY

In the handle device of JP 4914478 B, the restriction mechanism that restricts the rotation of the handle to the emergency operation position and the restriction release mechanism that releases the rotation restriction of the handle need to be provided, and thus the structure of the handle device is complicated. Therefore, the handle device of JP 4914478 B has room for improvement in simplification of the structure.

The present invention is intended to simplify the structure of a vehicle door outer handle device that can manually unlatch a door latch device.

The present invention provides a vehicle door outer handle device including: a base adapted to be attached to a door of a vehicle; a handle rotatably attached to a vehicle exterior side of the base; and a traction member having one end coupled to a door latch device attached to the door, the traction member being configured to switch the door latch device to an unlatched state. An operation member and a coupling lever are attached to the base, the operation member being operable when the handle is operated, and the coupling lever being coupled with the other end of the traction member and being configured to move in conjunction with an operation of the operation member and be able to directly transmit operating force of the operation member to the traction member are.

The operation member operable when the handle is operated, and the coupling lever that moves in conjunction with the operation of the operation member and can directly transmit the operating force of the operation member to the traction member are attached to the base. Accordingly, the door latch device can be manually switched to the unlatched state via the coupling lever and the traction member by the operation of the operation member. Since the traction member is coupled not to the handle but to the coupling lever that moves in conjunction with the operation of the operation member, it is not necessary to provide a mechanism for restricting the rotation of the handle. In addition, when manually switching the door latch device to the unlatched state, it is not necessary to provide a mechanism for releasing restriction by the restriction mechanism. Therefore, the structure of the vehicle door outer handle device can be simplified.

According to the present invention, the structure of the vehicle door outer handle device that can manually unlatch the door latch device can be simplified.

### BRIEF DESCRIPTION OF DRAWINGS

FIG. 1 is a block diagram of a handle device and a door latch device according to an embodiment of the present invention.

FIG. 2 is a perspective view of the handle device as viewed from the vehicle exterior side.

FIG. 3 is a cross-sectional view taken along the line III-III of FIG. 2.

FIG. 4 is a perspective view of the handle device from which a cover is removed, as viewed from the vehicle interior side.

FIG. 5 is a diagram illustrating operation of the handle device.

FIG. 6 is a perspective view of a handle, a transmission lever, a switch, an emergency button, and an open lever as viewed from the vehicle exterior side.

FIG. 7 is a perspective view of the handle, the transmission lever, the switch, the emergency button, and the open lever as viewed from the vehicle interior side.

FIG. 8 is an exploded perspective view of the handle, the transmission lever, the switch, the emergency button, and the open lever as viewed from the vehicle exterior side.

FIG. 9 is an exploded perspective view of the handle, the transmission lever, the switch, the emergency button, and the open lever as viewed from the vehicle interior side.

FIG. 10 is a rear view illustrating the handle, the transmission lever, and the switch in a non-operation state.

FIG. 11 is a rear view illustrating the handle, the transmission lever, and the switch in a normal opening operation state in which the handle is rotated to a first rotation position.

FIG. 12 is a rear view illustrating the handle, the transmission lever, and the switch in a state where the handle is rotated to a second rotation position.

FIG. 13 is a cross-sectional view illustrating the emergency button and the open lever taken along the line XIII-XIII of FIG. 10.

FIG. 14 is a rear view illustrating the handle, the transmission lever, the switch, the emergency button, and the open lever in an emergency opening operation state.

FIG. 15 is a cross-sectional view similar to FIG. 13, illustrating the emergency button and the open lever in the emergency opening operation state.

FIG. 16 is a cross-sectional view similar to FIG. 13, illustrating the emergency button and the open lever in an emergency opening operation state.

### DETAILED DESCRIPTION

Hereinafter, an embodiment of the present invention will be described with reference to the drawings.

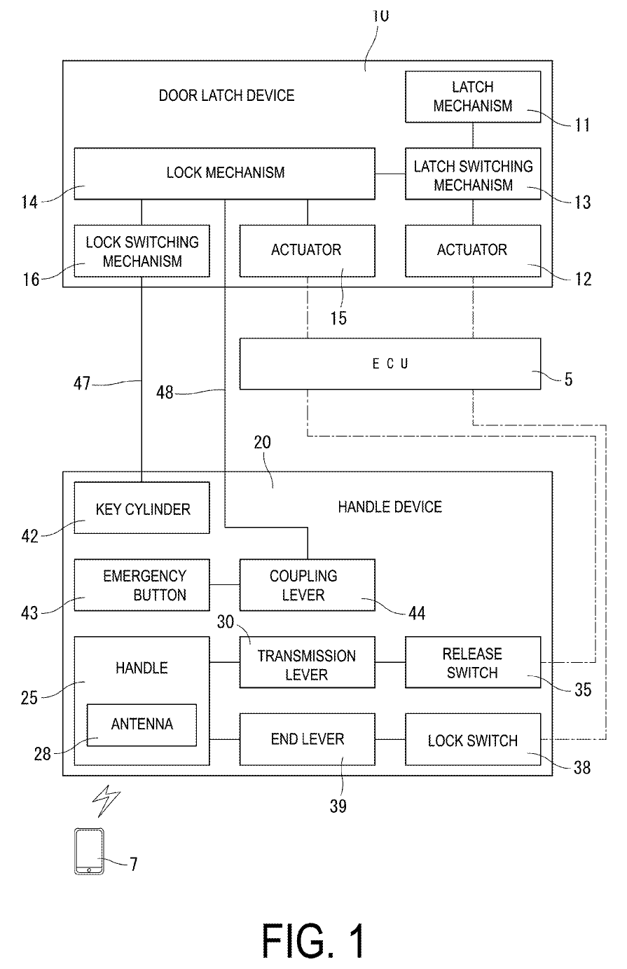

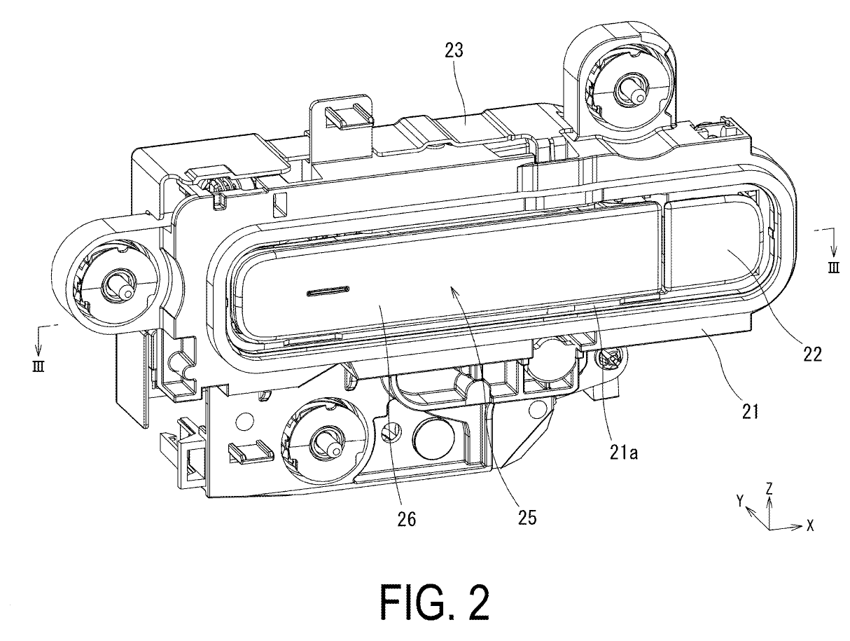

Referring to FIGS. 1 to 3, a vehicle door outer handle device 20 (hereinafter, referred to as a “handle device”) according to an embodiment of the present invention is attached to an outer panel 2 of a door 1, and enables the door 1 in a closed state to be opened by operating a door latch device 10 attached to the same door 1. The handle device 20 of the present embodiment is for a right side door in which a hinge shaft extends in a vehicle height direction. However, the handle device 20 may also be used for a left side door, a slide door, or a back door.

An X direction in the accompanying drawings is a vehicle length direction, a direction indicated by an arrow is a rear side, and a direction opposite to the arrow is a front side. A Y direction is a vehicle width direction, a direction indicated by an arrow is an inner side (vehicle interior side), and a direction opposite to the arrow is an outer side (vehicle exterior side). A Z direction is a vehicle height direction, a direction indicated by an arrow is an upper side, and a direction opposite to the arrow is a lower side.

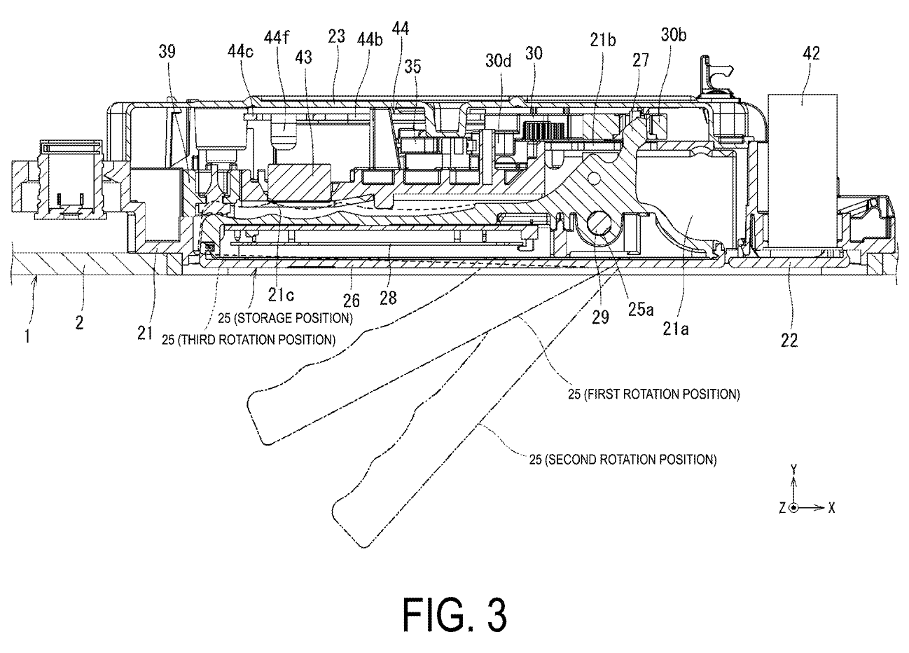

Referring to FIG. 1, the handle device 20 is communicably connected to the door latch device 10 attached to the same door 1 (see FIG. 3) via an electronic control unit (ECU) 5 mounted on a vehicle. The handle device 20 is mechanically connected to the door latch device 10.

The ECU 5 includes a calculation unit, a storage unit, and a communication unit (none of which are illustrated), reads out a program stored in advance in the storage unit, and executes information processing in accordance with steps instructed by the program. The ECU 5 performs Near Field Communication (NFC) with a portable device 7 that is compatible with Car Connectivity Consortium (CCC) and that is carried by a user. When the user is authenticated, the ECU 5 allows the door latch device 10 to electrically operate based on an input signal from the handle device 20. When the authentication with the portable device 7 is not established, the ECU 5 does not allow the door latch device 10 to operate. An antenna 28 for the ECU 5 to wirelessly communicate with the portable device 7 is accommodated in the handle device 20. A smartphone or a portable information terminal can be used as the portable device 7.

Describing the outline of the door latch device 10, the door latch device 10 is arranged on the vehicle interior side of the outer panel 2 of the door 1 (see FIG. 3). The door latch device 10 includes a latch mechanism 11, an actuator 12, a latch switching mechanism 13, a lock mechanism 14, an actuator 15, and a lock switching mechanism 16.

The latch mechanism 11 includes a fork and a claw, and is switched between a latched state and an unlatched state. In the latched state, the fork holding a striker of a vehicle body is locked by the claw, and thus the door 1 is held in the closed state (see FIG. 3). In the unlatched state, the locking by the claw is disengaged to allow the fork to release the striker, and thus the door can be opened.

Switching of the latch mechanism 11 from the unlatched state to the latched state is performed by the striker entering the fork due to closing of the door 1 in the open state (see FIG. 3). Switching of the latch mechanism 11 from the outside of the vehicle from the latched state to the unlatched state (unlatching operation) is performed by an operation of the handle device 20. However, the operation of the handle device 20 is different between a normal state in which the latch mechanism 11 can be electrically actuated by the actuator 12 via the latch switching mechanism 13 and an emergency state in which the latch mechanism 11 cannot be actuated. The operation of the handle device 20 when switching the latch mechanism 11 will be described in detail below.

The lock mechanism 14 is configured by a plurality of levers and the like, and is switched between an unlocked state and a locked state. In the unlocked state, the latch mechanism 11 can be switched to the unlatched state via the latch switching mechanism 13. In the locked state, the latch mechanism 11 cannot be switched to the unlatched state via the latch switching mechanism 13.

Switching of the lock mechanism 14 between the unlocked state and the locked state from the outside of the vehicle is performed by the operation of the handle device 20. However, switching of the lock mechanism 14 from the locked state to the unlocked state from the outside of the vehicle is different between in a normal state where the lock mechanism 14 can be electrically actuated by the actuator 15 and in an emergency state where the lock mechanism 14 cannot be actuated. The operation of the handle device 20 when switching the lock mechanism 14 will be described in detail below.

Here, the normal state means a case where authentication with the portable device 7 is established, the battery capacity of the vehicle is sufficient, and the actuators 12, 15 can be actuated. The emergency state includes the following two cases. The first case is a case where the battery capacity of the vehicle is insufficient and the actuators 12, 15 cannot be actuated. The second case is a case where authentication by the ECU 5 is not established due to a shortage of the battery capacity (battery exhaustion) of the predetermined portable device 7.

Next, the handle device 20 of the present embodiment will be specifically described.

The handle device 20 includes a configuration for electrically actuating the door latch device 10 in a normal state and a configuration for manually actuating the door latch device 10 in an emergency state.

Referring to FIGS. 1 to 4, the handle device 20 includes a base 21 attached to the vehicle interior side of the outer panel 2. The base 21 is provided with a recessed portion 21a recessed from the vehicle exterior side to the vehicle interior side. A key cover 22 is attached to the rear side of the recessed portion 21a in the vehicle length direction so as to be openable and closable. An end portion on the vehicle interior side of the base 21 is closed by a cover 23.

The handle device 20 includes a handle 25 to be rotationally operated in any of normal and emergency states, and a transmission lever 30 rotatable in conjunction with the rotation of the handle 25.

The handle 25 includes an antenna 28 therein, and is attached to the inside of the recessed portion 21a so as to be located on the vehicle exterior side of the base 21. The handle 25 is rotatable about a rotation shaft 29 extending in the vehicle height direction. Specifically, the handle 25 is rotatable between a storage position indicated by a solid line in FIG. 3 and a second rotation position (an emergency operation position) indicated by a double-dashed line in FIG. 3 via a first rotation position (normal operation position) indicated by a dashed line in FIG. 3. The handle 25 is rotatable between the storage position indicated by the solid line in FIG. 3 and a third rotation position (normal locking operation position) indicated by a broken line in FIG. 3.

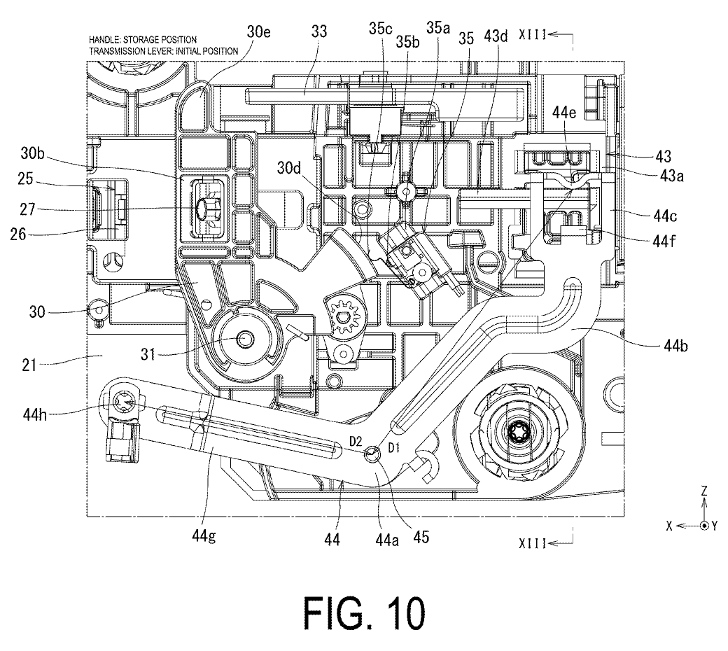

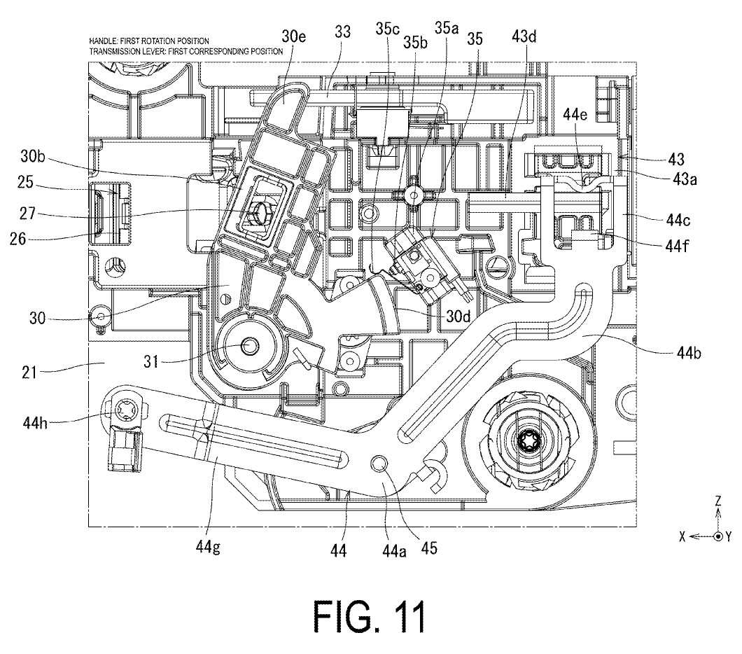

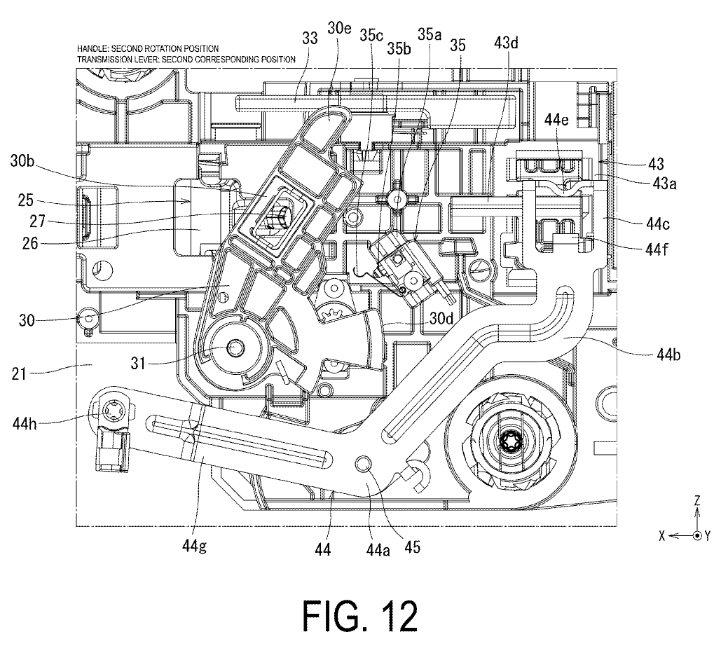

The transmission lever 30 is attached to the vehicle interior side of the base 21. The transmission lever 30 is rotatable about a rotation shaft 31 extending in the vehicle width direction. Specifically, the transmission lever 30 is rotatable to an initial position (see FIG. 10) corresponding to the storage position, a first corresponding position (see FIG. 11) corresponding to the first rotation position, a second corresponding position (see FIG. 12) corresponding to the second rotation position, and a third corresponding position (not illustrated) corresponding to the third rotation position by rotationally operating the handle 25.

The handle device 20 includes a release switch 35 and a lock switch 38 for electrically actuating the door latch device 10 in a normal state. These switches 35, 38 are each connected to the ECU 5, and output a signal in an ON state and do not output a signal in an OFF state.

The release switch 35 is a detection unit that detects an opening operation of the door 1 in a normal state. The release switch 35 is attached to the vehicle interior side of the base 21 so as to be adjacent to the transmission lever 30, and detects the opening operation (normal opening operation) of the handle 25 from the storage position to the first rotation position via the transmission lever 30.

The lock switch 38 is a detection unit that detects a locking operation of the lock mechanism 14 in a normal state. The lock switch 38 is attached to the vehicle interior side of the base 21 so as to be adjacent to an end lever 39, and detects the rotating operation (normal locking operation) of the handle 25 from the storage position to the third rotation position via the end lever 39.

The end lever 39 is attached to an end portion on the front side in the vehicle length direction of the recessed portion 21a of the base 21 so as to be adjacent to the handle 25 on the vehicle interior side. The end lever 39 is rotated toward the vehicle interior side around a shaft portion 39a extending in the vehicle length direction in conjunction with the rotation of the handle 25 from the storage position to the third rotation position.

The handle device 20 includes a key cylinder 42, an emergency button (operation member) 43, and a coupling lever 44 for manually operating the door latch device 10 in an emergency state.

The key cylinder 42 is attached adjacent to the rear side of the handle 25 in the vehicle length direction in the base 21. The key cylinder 42 is normally hidden by the key cover 22. The other end of a connection rod 47, one end of which is coupled to the lock switching mechanism 16 is coupled to the key cylinder 42.

The emergency button 43 is attached to the recessed portion 21a of the base 21 so as to be adjacent to the rear side of the end lever 39 in the vehicle length direction. The emergency button 43 is rotatable about a shaft portion (first rotation shaft) 21d extending in the vehicle length direction. The emergency button 43 is disposed on the vehicle interior side of the handle 25 and is hidden by the handle 25 when the handle 25 is at the storage position. The emergency button 43 is exposed to the vehicle exterior side when the handle 25 is rotated to the second rotation position.

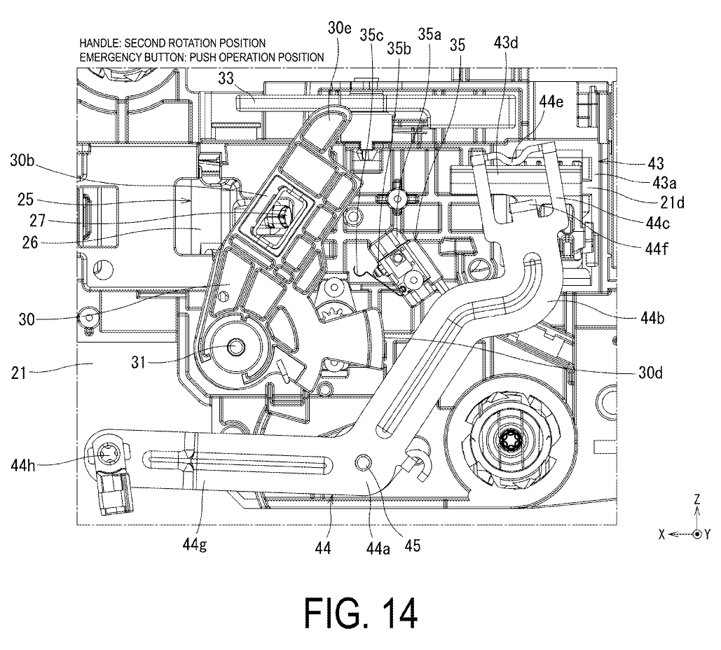

The coupling lever 44 is disposed on the vehicle interior side of the base 21, and is rotatable about a rotation shaft (second rotation shaft) 45 extending in the vehicle width direction in conjunction with the rotation of the emergency button 43 (see FIGS. 12 and 14). The other end of a connection cable (traction member) 48, one end of which is coupled to the lock mechanism 14 is coupled to the coupling lever 44.

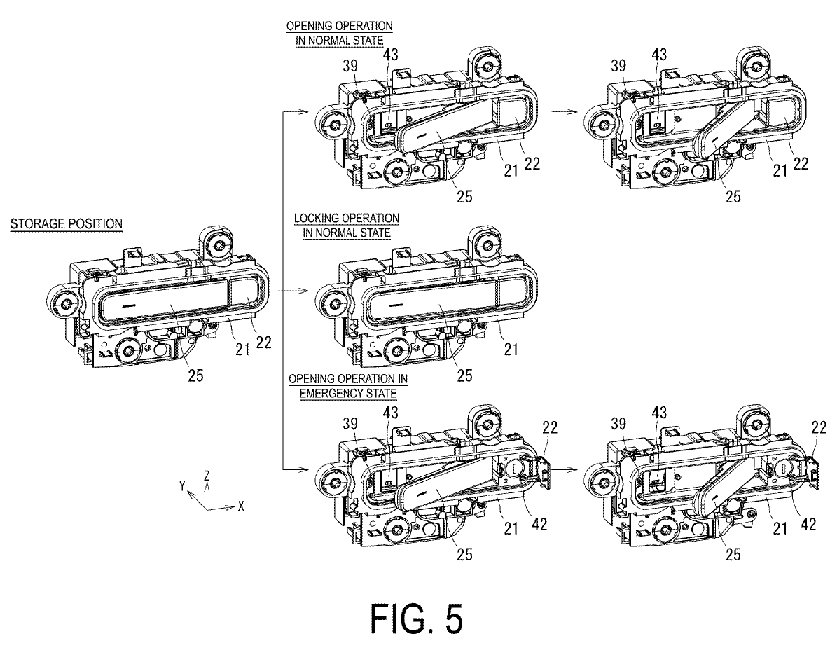

Next, the operation of the handle device 20 in a normal state and in an emergency state will be described with reference to FIGS. 1, 3, and 5.

### Opening Operation in Normal State

When opening the door 1 in a normal state, the user rotates the handle 25 from the storage position to the first rotation position. As a result, as illustrated in FIGS. 10 and 11, the transmission lever 30 is rotated from the initial position to the first corresponding position in conjunction with the rotation of the handle, thereby switching the release switch 35 from an ON state to an OFF state. The ECU 5 determines that the normal opening operation has been performed by the switching of the input signal from the release switch 35, and operates the actuator 15 to switch the lock mechanism 14 to the unlocked state. Thereafter, the actuator 12 is operated to switch the latch mechanism 11 to the unlatched state via the latch switching mechanism 13. In this state, the user pulls the handle 25 toward the vehicle exterior side, and thus the handle 25 is rotated to the second rotation position and thereafter the door 1 can be opened.

### Locking Operation in Normal State

When the door 1 in the open state is closed, the latch mechanism 11 is switched from the unlatched state to the latched state. In this state, when locking the door 1 in a normal state, the user rotates the handle 25 from the storage position to the third rotation position. As a result, the end lever 39 is rotated toward the vehicle interior side in conjunction with the rotation of the handle, thereby switching the lock switch 38 from an ON state to an OFF state. The ECU 5 determines that the normal locking operation has been performed by the switching of the input signal from the lock switch 38, and operates the actuator 15 to switch the lock mechanism 14 to the locked state.

### Opening Operation in Emergency State

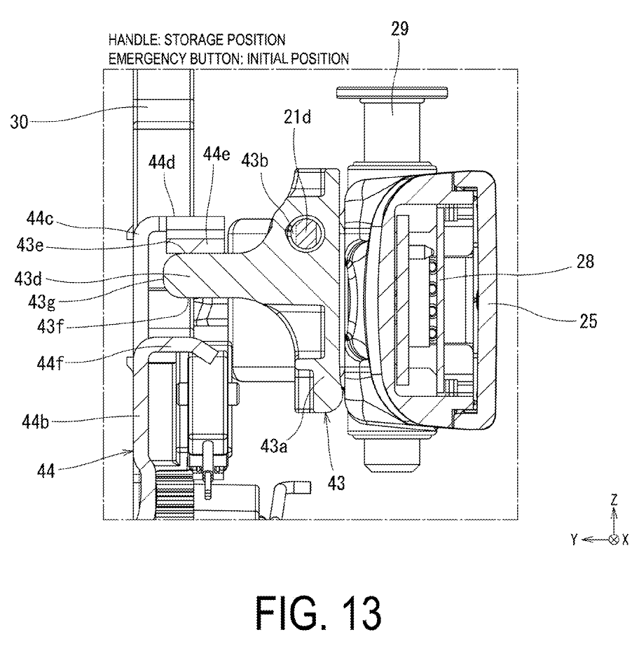

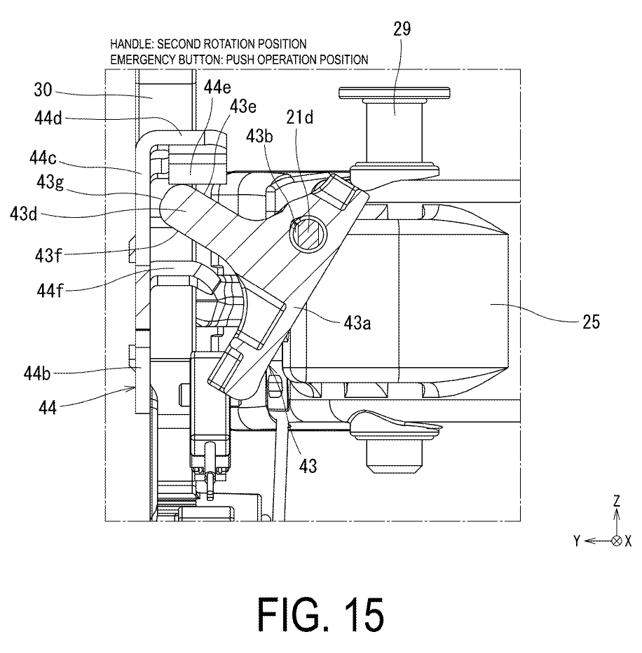

When opening the door 1 in an emergency state, the user rotates the handle 25 from the storage position to the first rotation position. Thereafter, the user opens the key cover 22, inserts a predetermined mechanical key (not illustrated) into the key cylinder 42, and operates the key cylinder 42. As a result, the lock switching mechanism 16 is operated via the connection rod 47, thereby switching the lock mechanism 14 to the unlocked state. Thereafter, the user rotates the handle 25 to the second rotation position and pushes the exposed emergency button 43 toward the vehicle interior side. As a result, as illustrated in FIGS. 13 to 15, the coupling lever 44 is rotated in conjunction with the operation of the emergency button, thereby operating the latch switching mechanism 13 via the connection cable 48 and the lock mechanism 14 to switch the latch mechanism 11 to the unlatched state. In this state, the user can open the door 1 by pulling the handle 25 toward the vehicle exterior side.

In an emergency state, even if a third party who does not possess the predetermined mechanical key pushes the emergency button 43, the lock mechanism 14 is in the locked state; therefore, the latch mechanism 11 cannot be switched to the unlatched state. Accordingly, the door 1 cannot be opened.

Next, the configurations of the handle 25, the transmission lever 30, and the release switch 35 will be described more specifically.

In the present embodiment, in order to reliably detect the normal opening operation of the handle 25 by the release switch 35 via the transmission lever 30, the handle 25, the transmission lever 30, and the release switch 35 are configured as follows.

Referring to FIGS. 3, 6, and 7, the handle 25 is a flush handle that includes a handle main body 26 elongated in the vehicle length direction and extending flush with the outer panel 2. The handle main body 26 is disposed in the recessed portion 21a of the base 21 and is exposed to the vehicle exterior side. The antenna 28 is accommodated inside the handle main body 26.

The handle 25 further includes a lever operating portion 27 that operates the transmission lever 30. The lever operating portion 27 protrudes from the handle main body 26 toward the vehicle interior side. The lever operating portion 27 extends through a penetrated portion 21b formed in the recessed portion 21a, and extends to the transmission lever 30 disposed on the vehicle interior side of the base 21.

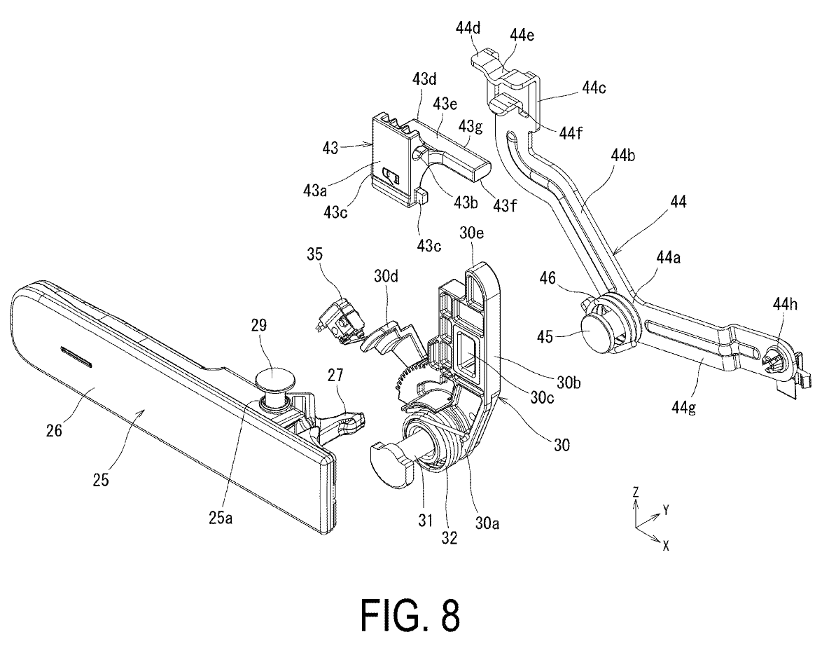

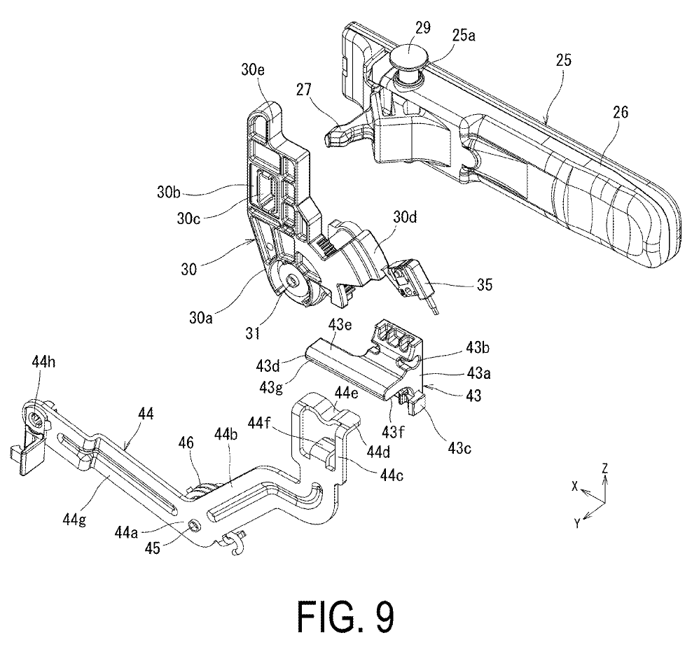

Referring to FIGS. 3, 8, and 9, the handle 25 is rotatably supported by the rotation shaft 29 that is attached to the base 21 so as to extend in the vehicle height direction. A shaft hole 25a of the handle 25 is located in front of a rear end in the vehicle length direction of the handle at an interval therewith. More specifically, the shaft hole 25a is formed on the front side in a region located on the rearmost side when the handle main body 26 is divided into four equal parts in the vehicle length direction. The lever operating portion 27 is disposed at a portion of the handle 25 in which the shaft hole 25a is formed.

When the handle 25 is in the storage position indicated by the solid line in FIG. 3, the handle main body 26 is stored in the recessed portion 21a. When the handle 25 is at the first rotation position (normal operation position) indicated by the dashed line in FIG. 3, a front end of the handle main body 26 in the vehicle length direction protrudes toward the vehicle exterior side. When the handle 25 is at the second rotation position (emergency operation position) indicated by the double-dashed line in FIG. 3, the front end of the handle main body 26 in the vehicle length direction protrudes further toward the vehicle exterior side than at the first rotation position. When the handle 25 is at the third rotation position (normal locking operation position) indicated by the broken line in FIG. 3, the front end of the handle main body 26 in the vehicle length direction is fitted into the recessed portion 21a.

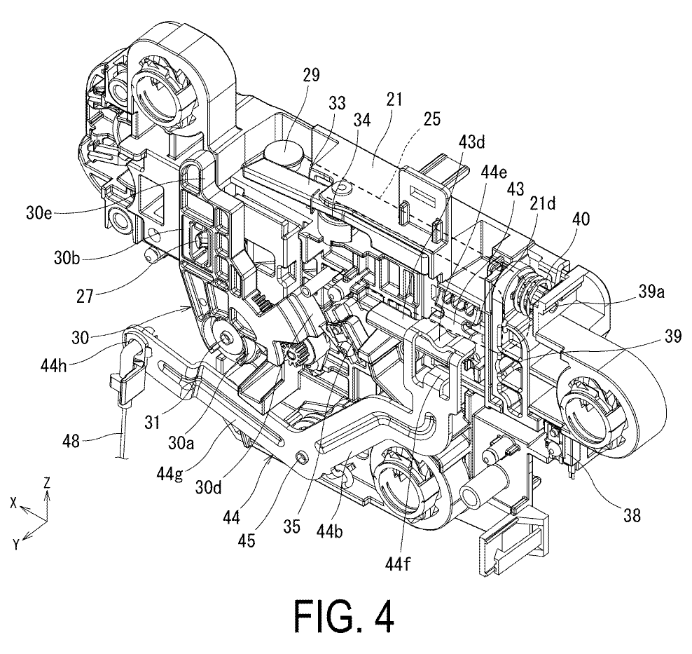

The handle 25 is biased from the second rotation position to the storage position by a spring 32 that biases the transmission lever 30 to the initial position (see FIG. 10). The handle 25 is biased from the third rotation position to the storage position by a spring 40 (see FIG. 4) that biases the end lever 39 to an initial position. The force of the spring 40 biasing the end lever 39 is stronger than the force of the spring 32 biasing the transmission lever 30. Thus, the handle 25 is held in the storage position in contact with the end lever 39 in a non-operation state.

Referring to FIGS. 4, 6 and 7, the transmission lever 30 is disposed in the base 21 so as to be located on the inner side of the lever operating portion 27 in the vehicle width direction. The transmission lever 30 is rotatably supported by the rotation shaft 31 that is attached to the base 21 so as to extend in the vehicle width direction. The transmission lever 30 is biased from the second corresponding position (see FIG. 12) to the initial position (see FIG. 10) by the spring 32 having one end locked to the base 21 and the other end locked to the transmission lever 30.

The transmission lever 30 includes a base portion 30a supported by the rotation shaft 31 so as to be rotatable about the rotation shaft 31. The transmission lever 30 also includes an operation receiving portion 30b and a switch operating portion 30d that protrudes from the base portion 30a radially outward around the rotation shaft 31.

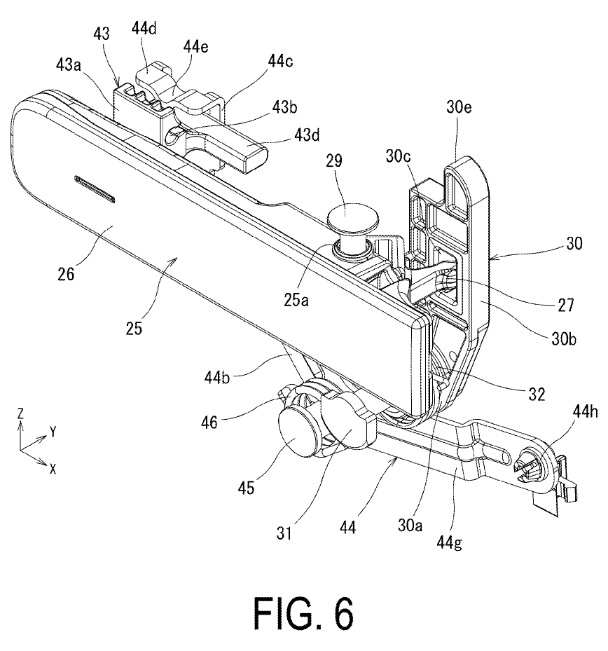

Referring to FIGS. 6 to 9, the operation receiving portion 30b protrudes upward from the base portion 30a when the transmission lever 30 is located at the initial position. The operation receiving portion 30b includes a rectangular through hole 30c through which the lever operating portion 27 of the handle 25 is inserted in a freely movable state, and receives an operation by the lever operating portion 27. The lever operating portion 27 comes into contact with a hole edge of the through hole 30c by the rotation of the handle 25 from the storage position toward the first rotation position. Thus, the transmission lever 30 rotates clockwise from the initial position (see FIG. 10) toward the first corresponding position (see FIG. 11) when viewed from the vehicle interior side. Also, the lever operating portion 27 comes into contact with the hole edge of the through hole 30c by the rotation of the handle 25 from the storage position toward the third rotation position. Thus, the transmission lever 30 rotates counterclockwise from the initial position (see FIG. 10) toward the third corresponding position when viewed from the vehicle interior side.

The switch operating portion 30d protrudes from the base portion 30a toward the front side in the vehicle length direction, and switches the release switch 35 between the ON state and the OFF state. The switch operating portion 30d has a fan shape and has an arc-shaped outer peripheral surface around the rotation shaft 31. As illustrated in FIGS. 3 and 10, when the handle 25 is at the storage position, the switch operating portion 30d of the transmission lever 30 at the initial position presses the release switch 35 and turns the release switch 35 into the ON state. As illustrated in FIGS. 3 and 11, when the handle 25 is rotated to the first rotation position, the switch operating portion 30d of the transmission lever 30 rotated to the first corresponding position releases the pressing of the release switch 35 and turns the release switch 35 into the OFF state. While the transmission lever 30 rotates from the initial position (see FIG. 10) to the first corresponding position (see FIG. 11), the switch operating portion 30d keeps pressing the release switch 35 to maintain the release switch 35 in the ON state. As just described, the angular range of the fan-shaped switch operating portion 30d is set so as to switch the release switch 35 between the ON state and the OFF state.

Referring to FIGS. 4, 8 and 9, the transmission lever 30 includes, at an upper end of the operation receiving portion 30b, a restriction receiving portion 30e that restricts the rotation of the transmission lever 30 by contacting a restriction lever 33. The restriction lever 33 is rotatably attached to an upper portion of the base 21 and is biased by a spring 34 to a non-restriction position illustrated in FIG. 4. The restriction lever 33 is formed of a mass body having a predetermined weight, and when an impact load is applied to the door 1 (FIG. 3) from the vehicle exterior side to the vehicle interior side due to a collision or the like, the restriction lever 33 is brought into a state of being relatively rotated counterclockwise in FIG. 4 with respect to the base 21 by an inertial force (restriction position). The restriction lever 33 at the restriction position comes into contact with the restriction receiving portion 30e and restricts the transmission lever 30 from rotating from the initial position (see FIG. 10) to the first corresponding position (see FIG. 11). Thus, the release switch 35 is prevented from being switched from the ON state to the OFF state, thereby preventing the door latch device 10 from being unintentionally unlatched by the ECU 5 illustrated in FIG. 1.

Referring to FIGS. 4, 10 and 11, the release switch 35 is attached to the vehicle interior side of the base 21 so as to be adjacent to the front side of the switch operating portion 30d of the transmission lever 30 in the vehicle length direction. The release switch 35 includes a limit switch that includes a switch main body 35a and a movable portion 35b retractable with respect to the switch main body 35a. The release switch 35 includes an elastic piece 35c for coming into contact with the switch operating portion 30d to allow the movable portion 35b to be retracted into the switch main body 35a and thereby switching the release switch to the ON state. However, the release switch 35 may be configured without the elastic piece 35c such that the movable portion 35b is directly pressed by the switch operating portion 30d.

The switch operating portion 30d is in contact with the elastic piece 35c until the transmission lever 30 reaches the first corresponding position (see FIG. 11) from the third corresponding position (not illustrated) via the initial position (see FIG. 10). Therefore, during this period, the movable portion 35b is in the retracted state, and the release switch 35 is maintained in the ON state. On the other hand, when the transmission lever 30 reaches the first corresponding position (see FIG. 11), the switch operating portion 30d is separated from the elastic piece 35c. Therefore, the movable portion 35b advances, and the release switch 35 is turned to the OFF state. Also, when the transmission lever 30 rotates from the first corresponding position (see FIG. 11) to the second corresponding position (see FIG. 12), the switch operating portion 30d is maintained in the separated state from the elastic piece 35c. Therefore, the movable portion 35b maintains the advanced state, and the release switch 35 is maintained in the OFF state.

As described above, the release switch 35 is a so-called normally on type switch that is turned to the ON state in contact with the transmission lever 30 when the handle 25 is at the storage position, which is the non-operation state and is turned to the OFF state when the handle 25 is rotated to the first rotation position. Therefore, compared to a normally off type switch, influences of dimensional variations within the tolerances when manufacturing the base 21, the handle 25, and the transmission lever 30 and variations in mounting position with respect to the base 21 can be reduced, and the state of the release switch 35 can be switched. In particular, when the transmission lever 30 and the release switch 35 are attached to the base 21, the contact state therebetween can be confirmed. Therefore, an unintended operational failure of the handle device 20 including the door latch device 10 can be suppressed.

Next, the configurations of the emergency button 43 and the coupling lever 44 will be described more specifically.

In the present embodiment, the emergency button 43 and the coupling lever 44 are configured as follows in order to manually unlatch the door latch device 10 (see FIG. 1) with a simple configuration without providing a mechanism that complicates the structure.

Referring to FIGS. 3 and 4, the emergency button 43 is disposed in a rectangular penetrated portion 21c formed on the front side in the vehicle length direction on the bottom of the recessed portion 21a of the base 21. The emergency button 43 is rotatably supported by a shaft portion 21d extending in the vehicle length direction along the base 21. The emergency button 43 includes an operating portion 43a and a protruding portion 43d, and is biased to an initial position (see FIG. 13) by a spring 46 of the coupling lever 44.

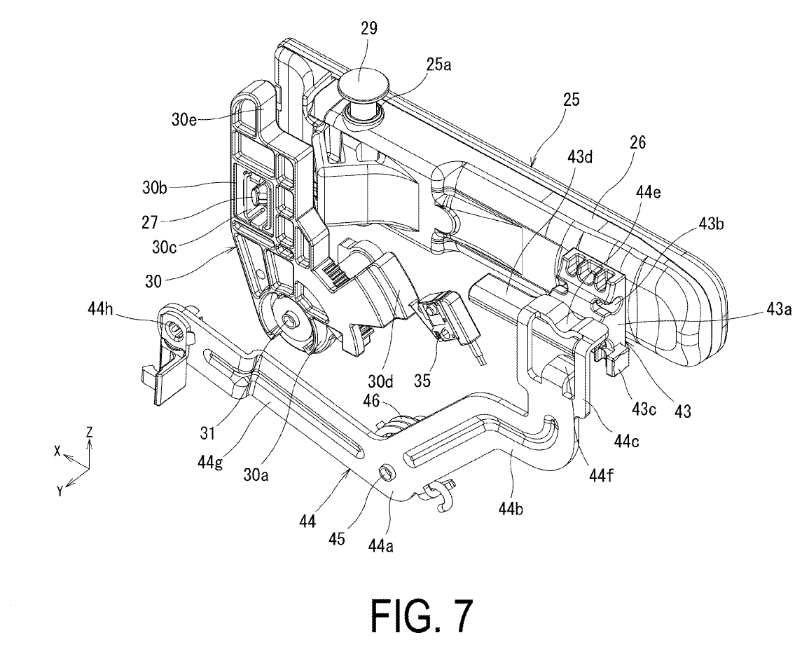

Referring to FIGS. 7 to 9, the operating portion 43a has a rectangular shape that can be disposed in the penetrated portion 21c. A shaft hole 43b into which the shaft portion 21d is fitted is provided in an upper portion of the operating portion 43a. Thus, the operating portion 43a is rotated such that the lower end thereof enters the upper side and the vehicle interior side by push operation from the vehicle exterior side to the vehicle interior side. A stopper portion 43c for stopping excessive rotation toward the vehicle exterior side is provided in a protruding manner at a lower portion of the operating portion 43a.

Referring to FIG. 3, when the handle 25 is at the storage position, the operating portion 43a is located on the vehicle interior side of the handle 25 and cannot be operated from the vehicle exterior side. The operating portion 43a is located on the vehicle interior side of the handle 25 even when the handle 25 is rotated to the first rotation position, and is difficult to operate from the vehicle exterior side. When the handle 25 is rotated to the second rotation position, the operating portion 43a is exposed and can be pushed from the vehicle exterior side.

Referring to FIGS. 7 to 9, the protruding portion 43d protrudes from the operating portion 43a toward the vehicle interior side. The protruding portion 43d has a predetermined thickness in the vehicle height direction, has an elongated plate shape extending in the vehicle length direction, and protrudes toward the rear side of the operating portion 43a in the vehicle length direction. The length of the protruding portion 43d in the vehicle length direction is set based on the rotation range of the coupling lever 44. Both an upper surface 43e and a lower surface 43f of the protruding portion 43d are flat. A distal end 43g of the protruding portion 43d is chamfered to have a semicircular cross-section.

Referring to FIGS. 4, 10 and 14, the coupling lever 44 is configured to rotate in conjunction with the rotation of the emergency button 43 and unlatch the latch mechanism 11 (see FIG. 1) via the connection cable 48. The coupling lever 44 is rotatably supported by a rotation shaft 45 attached to a lower portion of the base 21. The rotation shaft 45 is located below the emergency button 43 and at an interval therewith on the rear side in the vehicle length direction, and extends in the vehicle width direction that is a direction intersecting with the base 21. The coupling lever 44 is biased from an operation position (see FIG. 14) to an initial position (see FIG. 12) by the spring 46 having one end locked to the base 21 and the other end locked to the coupling lever 44.

Referring to FIGS. 7 to 9, the coupling lever 44 includes a base portion 44a supported by the rotation shaft 45 so as to be rotatable about the rotation shaft 45. The coupling lever 44 has a substantially L-shape as a whole, and includes a first arm portion 44b and a second arm portion 44g that protrude from the base portion 44a radially outward around the rotation shaft 45.

When the coupling lever 44 is at the initial position, the first arm portion 44b extends from the base portion 44a toward the protruding portion 43d of the emergency button 43 while being inclined forward and upward in the vehicle length direction. An engaging portion 44c engageable with the protruding portion 43d is provided at a distal end of the first arm portion 44b.

A protruding piece 44d protruding toward the vehicle exterior side and extending in the vehicle length direction is provided at an upper end of the engaging portion 44c so as to be located above the protruding portion 43d at an interval therewith. A semicircular arc-shaped contact portion 44e protruding downward is provided at the center of the protruding piece 44d in the vehicle length direction. The upper surface 43e or the distal end 43g comes into point contact with the contact portion 44e by the rotation of the protruding portion 43d by push operation of the emergency button 43. As a result, the engaging portion 44c is pressed upward, and the coupling lever 44 rotates counterclockwise in FIG. 7.

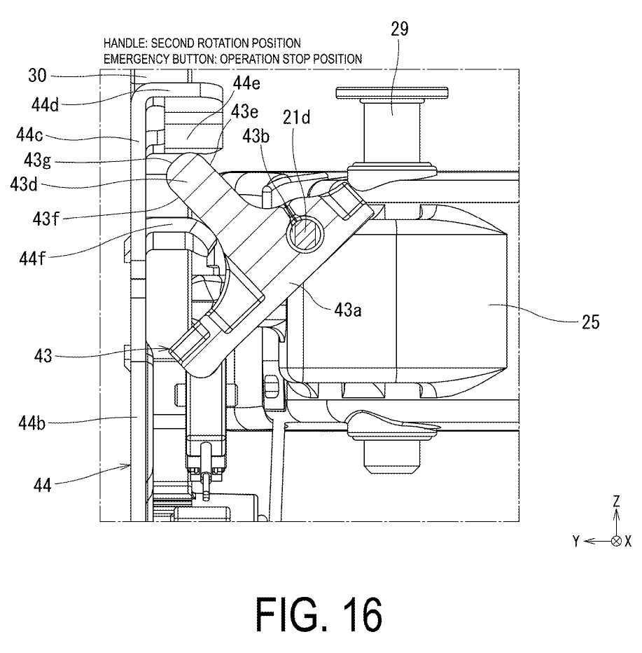

A tongue-shaped restricting portion 44f protruding toward the vehicle exterior side is provided at a lower portion of the engaging portion 44c so as to be located below the protruding portion 43d at an interval therewith. The restricting portion 44f comes into contact with the lower surface 43f of the protruding portion 43d by the rotation of the coupling lever 44 by the push operation of the emergency button 43, thereby restricting the emergency button 43 from further rotating (see FIG. 16). The distance between the restricting portion 44f and the contact portion 44e is larger than the thickness of the protruding portion 43d, and is set to a size that does not allow disengagement between the contact portion 44e and the protruding portion 43d. Here, the disengagement means that the emergency button 43 further rotates clockwise from the posture illustrated in FIG. 16 and thus the protruding portion 43d is separated from the contact portion 44e.

The second arm portion 44g protrudes in a different direction from the direction of the first arm portion 44b in the radial direction around the rotation shaft 45. More specifically, when the coupling lever 44 is at the initial position, the second arm portion 44g extends from the base portion 44a toward the rear side in the vehicle length direction so as to be located below the transmission lever 30 at an interval therewith. A coupling portion 44h to which a wire end of the connection cable 48 is coupled is provided at a distal end of the second arm portion 44g. The coupling portion 44h is formed of a hole penetrating in the vehicle width direction.

Referring to FIG. 10, a distance D1 from the rotation shaft 45 to the contact portion 44e is longer than a distance D2 from the rotation shaft 45 to the coupling portion 44h. This ensures the amount of movement (rotation angle) of the coupling portion 44h with respect to the amount of operation (rotation angle) of the emergency button 43. Therefore, the operating force of the emergency button 43 is directly transmitted to the connection cable 48, and the door latch device 10 (see FIG. 1) can be manually and reliably unlatched.

As described above, in the present embodiment, the door latch device 10 (see FIG. 1) is manually switched to the unlatched state via the coupling lever 44 and the connection cable 48 by the operation of the emergency button 43. Accordingly, a mechanism for restricting the rotation of the handle 25 and a mechanism for releasing restriction by the restriction mechanism are not required. As a result, the structure of the handle device 20 can be simplified.

The handle device 20 configured as described above has the following features.

The emergency button 43 operable when the handle 25 is rotationally operated to the second rotation position, and the coupling lever 44 that rotates in conjunction with the operation of the emergency button 43 and can directly transmit the operating force of the emergency button 43 to the connection cable 48 are attached to the base 21. Thus, the door latch device 10 can be manually switched to the unlatched state via the coupling lever 44 and the connection cable 48 by the operation of the emergency button 43. Since the connection cable 48 is connected not to the handle 25 but to the coupling lever 44 that moves in conjunction with the operation of the emergency button 43, it is not necessary to provide a mechanism for restricting the rotation of the handle 25. In addition, when the door latch device 10 is manually switched to the unlatched state, it is not necessary to provide the mechanism for releasing restriction by the restriction mechanism. As a result, the structure of the handle device 20 can be simplified.

The coupling lever 44 is provided with the restricting portion 44f that restricts movement of the emergency button 43. The emergency button 43 is rotatable about the shaft portion 21d extending along the base 21 by push operation from the vehicle exterior side to the vehicle interior side. Accordingly, excessive rotation of the emergency button 43 can be restricted, and thus engagement between the emergency button 43 and the coupling lever 44 can be prevented from being released. As a result, an unintended operational failure in an emergency state can be suppressed.

The coupling lever 44 includes the contact portion 44e that comes into point contact with the protruding portion 43d of the emergency button 43, which protrudes toward the vehicle interior side. Thus, the operating force of the emergency button 43 is converted into the rotating force of the coupling lever 44, and the coupling lever 44 can be rotated. In addition, frictional resistance between the contact portion 44e and the protruding portion 43d can be reduced. Accordingly, the operating force when the door latch device 10 is manually unlatched can be reduced, and thus operability of the user can be improved.

In the coupling lever 44, the distance D1 from the rotation shaft 45 to the contact portion 44e is longer than the distance D2 from the rotation shaft 45 to the coupling portion 44h. Accordingly, the amount of rotation of the coupling portion 44h with respect to the amount of operation of the emergency button 43 can be secured, and thus the door latch device 10 can be reliably unlatched. Moreover, since the operating force when the door latch device 10 is manually unlatched can be reduced, the operability of the user can be improved.

When the handle 25 is not operated, the operating portion 43a of the emergency button 43 is located on the vehicle interior side of the handle 25 and cannot be operated from the vehicle exterior side. Thus, an unintended erroneous operation of the emergency button 43 can be prevented.

The transmission lever 30 rotatable in conjunction with the rotation of the handle 25, and the release switch 35 that electrically operates the door latch device 10 by switching between the ON state and the Off state due to the rotation of the transmission lever 30 when the handle 25 is rotated from the storage position to the first rotation position are attached to the base 21. Therefore, in a normal state, the door latch device 10 can be reliably unlatched electrically by operating the handle 25 from the storage position to the first rotation position.

Note that the present invention is not limited to the configuration of the embodiments described above, and various modifications can be made.

For example, the emergency button 43 may be operable even in a posture other than the second rotation position (emergency operation position) as long as the emergency button 43 cannot be operated when the handle 25 is at the storage position.

The restricting portion 44f does not need to be provided at the engaging portion 44c as long as the engagement between the protruding portion 43d of the emergency button 43 and the contact portion 44e of the coupling lever 44 is not released.

The emergency button 43 is not limited to a rotation type by push operation, and may be a linear type by push operation or a slide type movable along the base 21 as long as the emergency button 43 is configured to be able to move the coupling lever 44.

The engaging portion 44c does not need to be provided with the contact portion 44e that comes into point contact with the emergency button 43 as long as the coupling lever 44 can be rotated by the operation of the emergency button 43. In addition, the relationship between the distance D1 from the rotation shaft 45 to the contact portion 44e and the distance D2 from the rotation shaft 45 to the coupling portion 44h may be changed as necessary.

The handle device 20 may not include the release switch 35 and the lock switch 38 that are adapted to electrically operate the door latch device 10.

What is claimed is:

1. A vehicle door outer handle device, comprising:
a base adapted to be attached to a door of a vehicle;
a handle rotatably attached to a vehicle exterior side of the base; and
a traction member having one end coupled to a door latch device attached to the door, the traction member being configured to switch the door latch device to an unlatched state,
wherein an operation member and a coupling lever are attached to the base, the operation member being operable when the handle is operated, and the coupling lever being coupled with the other end of the traction member and being configured to move in conjunction with an operation of the operation member and be able to directly transmit operating force of the operation member to the traction member.

2. The vehicle door outer handle device according to claim 1, wherein, the coupling lever is provided with a restricting portion configured to restrict movement of the operation member, and
the operation member can rotate about a first rotation shaft extending along the base by push operation from the vehicle exterior side to a vehicle interior side.

3. The vehicle door outer handle device according to claim 1, wherein the operation member includes an operating portion exposed to the vehicle exterior side when the handle is operated, and a protruding portion protruding from the operating portion toward a vehicle interior side, and
the coupling lever includes a contact portion configured to make point contact with the protruding portion.

4. The vehicle door outer handle device according to claim 3, wherein the coupling lever is rotatable about a second rotation shaft extending in a direction intersecting with the base, and includes a first arm portion protruding in a radial direction about the second rotation shaft, and a second arm portion protruding in a different direction from the first arm portion in the radial direction about the second rotation shaft,
the contact portion is provided at a distal end of the first arm portion,
a coupling portion to which the traction member is coupled is provided at a distal end of the second arm portion, and
a distance D1 from the second rotation shaft to the contact portion is longer than a distance D2 from the second rotation shaft to the coupling portion.

5. The vehicle door outer handle device according to claim 1, wherein when the handle is not operated, the operation member is located on a vehicle interior side of the handle as viewed from the vehicle exterior side and cannot be operated from the vehicle exterior side.

6. The vehicle door outer handle device according to claim 1, wherein the handle is rotatable between a storage position when the handle is not operated and an emergency operation position when the handle is operated, via a normal operation position, and
a transmission lever and a switch are attached to the base, the transmission lever being configured to rotate in conjunction with rotation of the handle, and the switch being configured to switch between an ON state and an OFF state by rotation of the transmission lever when the handle is rotated from the storage position to the normal operation position and thereby electrically operate the door latch device.

7. The vehicle door outer handle device according to claim 2, wherein the operation member includes an operating portion exposed to the vehicle exterior side when the handle is operated, and a protruding portion protruding from the operating portion toward a vehicle interior side, and
the coupling lever includes a contact portion configured to make point contact with the protruding portion.

8. The vehicle door outer handle device according to claim 7, wherein the coupling lever is rotatable about a second rotation shaft extending in a direction intersecting with the base, and includes a first arm portion protruding in a radial direction about the second rotation shaft, and a second arm portion protruding in a different direction from the first arm portion in the radial direction about the second rotation shaft,
the contact portion is provided at a distal end of the first arm portion,
a coupling portion to which the traction member is coupled is provided at a distal end of the second arm portion, and
a distance D1 from the second rotation shaft to the contact portion is longer than a distance D2 from the second rotation shaft to the coupling portion.

9. The vehicle door outer handle device according to claim 2, wherein when the handle is not operated, the operation member is located on a vehicle interior side of the handle as viewed from the vehicle exterior side and cannot be operated from the vehicle exterior side.

10. The vehicle door outer handle device according to claim 2, wherein the handle is rotatable between a storage position when the handle is not operated and an emergency operation position when the handle is operated, via a normal operation position, and
a transmission lever and a switch are attached to the base, the transmission lever being configured to rotate in conjunction with rotation of the handle, and the switch being configured to switch between an ON state and an OFF state by rotation of the transmission lever when the handle is rotated from the storage position to the normal operation position and thereby electrically operate the door latch device.
